(19) United States
(12) Patent Application Publication
(10) Pub. No.: US 2026/0051148 A1
(43) Pub. Date: Feb. 19, 2026

(54) GRAPH CUTS FOR EXPLAINABILITY

(71) Applicant: QUALCOMM TECHNOLOGIES, INC., San Diego, CA (US)

(72) Inventors: Adeel Ahsan PERVEZ, Klosterneuburg (AT); Phillip LIPPE, Amsterdam (NL); Efstratios GAVVES, Amsterdam (NL)

(21) Appl. No.: 19/101,568

(22) PCT Filed: Sep. 26, 2023
(86) PCT No.: PCT/US2023/075152

§ 371 Date: Feb. 5, 2025

(30) Foreign Application Priority Data
Sep. 28, 2022 (GR) 20220100795

(51) Int. Cl. G06V 10/762; G06N 3/042; G06V 10/44; G06V 10/77; G06V 10/771; G06V 10/82; G06V 20/70

(52) U.S. Cl. CPC G06V 10/7635; G06N 3/042; G06V 10/457; G06V 10/7715; G06V 10/82; G06V 10/771; G06V 20/70

(57) ABSTRACT

A processor-implemented method for implementing graph cuts for explainability using an artificial neural network (ANN) includes receiving, via the ANN, an input. The input is represented as a graph. The graph includes nodes connected by edges. The ANN determines a graph cut between a source node and a sink node associated with the input by solving a quadratic process with equality constraints. The ANN processes a subset of the input based on the graph cut to generate a prediction.

### CROSS-REFERENCE TO RELATED APPLICATION

The present application claims priority to Greek Patent Application No. 20220100795, filed on Sep. 28, 2022, and titled “GRAPH CUTS FOR EXPLAINABILITY,” the disclosure of which is expressly incorporated by reference in its entirety.

### FIELD OF THE DISCLOSURE

Aspects of the present disclosure generally relate to artificial neural networks, and more specifically to graph cuts for explainability.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Neural networks also have numerous applications in image-based processing of videos or video streams such as human pose estimation, object detection, semantic segmentation, as well as video compression and denoising. Unfortunately, such video processing is computationally intensive, which results in significant time and energy consumption.

### SUMMARY

The present disclosure is set forth in the independent claims, respectively. Some aspects of the disclosure are described in the dependent claims.

In some aspects of the present disclosure, a processor-implemented method includes receiving, via an artificial neural network (ANN), an input. The processor-implemented method further includes representing the input as a graph, the graph including a number of nodes connected by edges. The processor-implemented method still further includes determining, via the ANN, a graph cut between a source node and a sink node associated with the input by solving a quadratic process with equality constraints. The processor-implemented method also includes processing, via the ANN, a subset of the input based on the graph cut to generate a prediction.

Various aspects of the present disclosure are directed to an apparatus. The apparatus includes means for receiving, via an artificial neural network (ANN), an input. The apparatus further includes means for representing the input as a graph, the graph including a number of nodes connected by edges. The apparatus still further includes means for determining, via the ANN, a graph cut between a source node and a sink node associated with the input by solving a quadratic process with equality constraints. The apparatus also includes means for processing, via the ANN, a subset of the input based on the graph cut to generate a prediction.

In some aspects of the present disclosure, a non-transitory computer-readable medium with program code recorded thereon is disclosed. The program code is executed by a processor and includes program code to receive, via an artificial neural network (ANN), an input. The program code further includes program code to represent the input as a graph, the graph including a number of nodes connected by edges. The program code still further includes program code to determine, via the ANN, a graph cut between a source node and a sink node associated with the input by solving a quadratic process with equality constraints. The program code also includes program code to process, via the ANN, a subset of the input based on the graph cut to generate a prediction.

Various aspects of the present disclosure are directed to an apparatus. The apparatus has at least one memory and one or more processors coupled to the at least one memory. The processor(s) is configured to receive, via an artificial neural network (ANN), an input. The processor(s) is further configured to represent the input as a graph, the graph including a number of nodes connected by edges. The processor(s) is still further configured to determine, via the ANN, a graph cut between a source node and a sink node associated with the input by solving a quadratic process with equality constraints. The processor(s) is also configured to process, via the ANN, a subset of the input based on the graph cut to generate a prediction.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIG. 5A is a diagram illustrating example cuts of an example graph, in accordance with various aspects of the present disclosure.

FIG. 5B is a diagram illustrating an example graph for illustrating an example minimum s-t cut problem, in accordance with various aspects of the present disclosure.

FIG. 6 is a block diagram illustrating an example architecture for determining graph cuts, in accordance with various aspects of the present disclosure.

FIG. 7A is a block diagram illustrating the graph partitioning module of FIG. 6 for partitioning a graph, in accordance with various aspects of the present disclosure.

FIG. 7B is a diagram illustrating example pseudocode for partitioning a graph, in accordance with various aspects of the present disclosure.

FIG. 8A is a diagram illustrating an example object-centric feature representation, in accordance with various aspects of the present disclosure.

FIG. 8B is a diagram illustrating example pseudocode for object-centric representation, in accordance with various aspects of the present disclosure.

FIG. 8C is a diagram illustrating example pseudocode for object-centric representation, in accordance with various aspects of the present disclosure.

FIG. 9 is a flow diagram illustrating an example processor-implemented method for implementing graph cuts for explainability using an artificial neural network, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed, neural networks have numerous applications in image-based processing of videos or video streams such as human pose estimation, object detection, and semantic segmentation, as well as video compression and denoising. Unfortunately, such video processing is computationally intensive, which results in significant time and energy consumption.

Explainability is an area of growing interest in artificial intelligence. One motivation for explainability is to increase reliability in predictions generated in deep neural network models. Explainability involves determining a subset of an input that is more important for producing the output prediction. Thus, by understanding the explainability of a model, optimizations in processing of images may be realized by enabling the processing of only a subset of pixels in an image rather than the entire image to determine the output prediction, for example.

Graph cut techniques have been applied to various problems in computer vision and graphics. A graph cut may refer to a process of partitioning a graph including multiple vertices (may also be referred to as nodes) coupled by edges into one or more subsets of vertices.

One example of a graph cut problem is the minimum s-t cut problem. A directed graph G=(V, E), where V represents vertices and E represents edges, with weights for edges (u, v) denoted by w_{u,v} and two special vertices, namely a source node s and a sink node t, may represent an input. The input may comprise (but is not limited to) an image or grid of features, for example. The minimum s-t cut problem involves finding a partition of the vertex set V into subsets V₁ and V₂, V₁ ∩V₂=Ø, such that sϵV₁, tϵV₂ and the sum of the weights w_{u,v} of the edges crossing the partition from V₁ to V₂ may be minimized.

However, the problem of finding minimum s-t cuts in graphs is a combinatorial optimization problem, which may be related to a max-flow problem. Solving the combinatorial optimization problem may be challenging.

Accordingly, aspects of the present disclosure are directed to graph cuts for explainability in neural network models. Aspects of the present disclosure may provide techniques for determining differentiable solutions for k-partitioning and matching problems. Furthermore, the techniques disclosed may also be efficient and scalable for object-centric representation learning.

In some aspects, a topology-aware k-partitioning problem may be formulated as the problem of solving k minimum s-t cuts in an image graph or the problem of matching as a bipartite matching problem, for example. One feature of the k-partitioning problem (e.g., minimum s-t cuts) and the bipartite matching problem may be that both problems can be formulated as linear processes. Such processes may be included as layers in a neural network by parameterizing the coefficients of an objective function of the linear processes with neural networks. However, the linear processes may not be continuously differentiable with respect to the objective function coefficients. Another problem may be that batch solutions of the linear processes using conventional solvers may be too inefficient for neural network models, especially when the processes have a large number of variables and constraints.

To address these and other problems, linear processes may be approximated by regularized equality constrained quadratic processes, and optimality condition (e.g., Karush-Kuhn-Tucker (KKT) matrix) factorizations may be pre-computed so that optimality equations may be quickly solved during training.

One advantage of using equality constrained quadratic processes may be that such processes may be solved from the optimality conditions. Combined with the appropriate pre-computed factorizations for the task of object-centric learning, the optimality conditions can be solved very efficiently during training. Another advantage of using quadratic processing approximations may be that quadratic processes may be differentiated relative to process parameters using an implicit function theorem.

To learn the objective coefficients of the cut problem by a neural network, the linear process may have to be solved differentiably, similar to a hidden layer, for example. Accordingly, the linear process may be relaxed to a quadratic process. Then, differentiable mathematical techniques may be employed to obtain gradients. In doing so, the KKT optimality conditions may be solved, which then may produce gradients relative to the parameters of the quadratic process. However, with a naive relaxation, computations for both the forward pass and the backward pass may still be too computationally expensive (e.g., in terms of time and energy consumption) for use in object-centric representation learning applications.

Given that many techniques employed for differentiably solving quadratic processes may be limited to smaller program sizes, aspects of the present disclosure provide optimizations in the gradient computation specific to the problem of solving graph cuts for image data. For instance, an underlying s-t flow graph may remain unchanged across equally sized images. Thus large matrix factorization may be pre-computed. Furthermore, the forward pass may be replaced by a regularized equality constrained quadratic process constructed from the linear processing formulation of the minimum s-t cut problem. When combined with such task-specific optimizations, equality constrained quadratic processes may be solved more efficiently (and in some cases, significantly more efficiently) than general quadratic processes with mixed equality and inequality constraints. The regularization of slack variables may ensure that an output of the disclosed equality constrained quadratic process may still be interpreted as an s-t cut solution. The use of sparse matrix computations in the forward and backward passes may ensure that time and memory usage may be significantly reduced.

Accordingly, particular aspects of the subject matter described in this disclosure may be implemented to realize one or more of the following potential advantages. In some examples, the described techniques may reduce memory and/or power consumption and/or may enable performing efficient image segmentation, object-centric feature representation, and explanability with respect to image data. Moreover, the described techniques may also enable differentiable graph cuts as well as topology-aware feature selection in data where the structure can be represented by a graph.

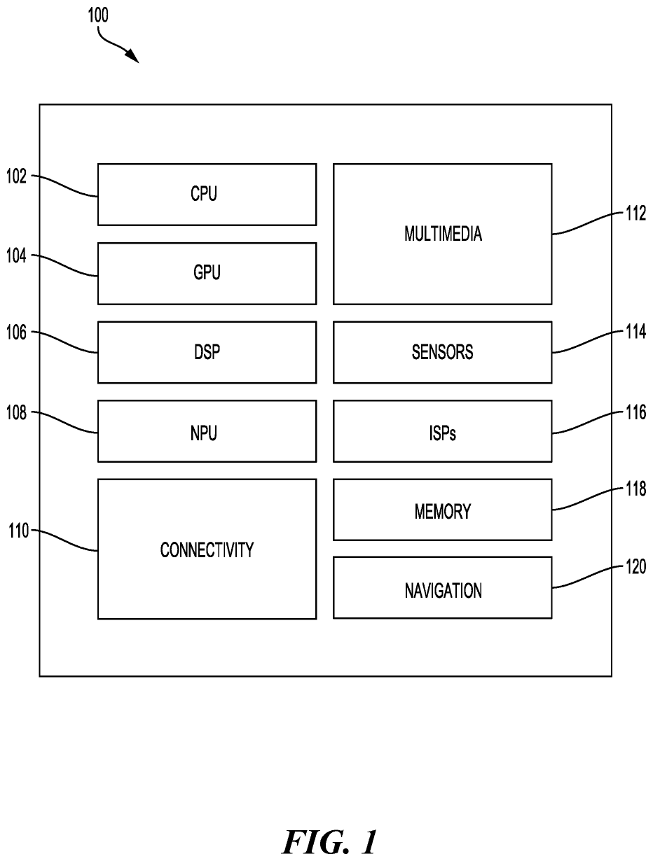

FIG. 1 illustrates an example implementation of a system-on-a-chip (SOC) 100, which may include a central processing unit (CPU) 102 or a multi-core CPU configured for implementing graph cuts for explainability. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive, via an artificial neural network, an input. The general-purpose processor 102 may also include code to represent the input as a graph. The graph includes nodes connected by edges. The general-purpose processor 102 may additionally include code to determine, via the ANN, a graph cut between a source node and a sink node associated with the input by solving a quadratic process with equality constraints. The general-purpose processor 102 may further include code to process, via the ANN, a subset of the input based on the graph cut to generate a prediction.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

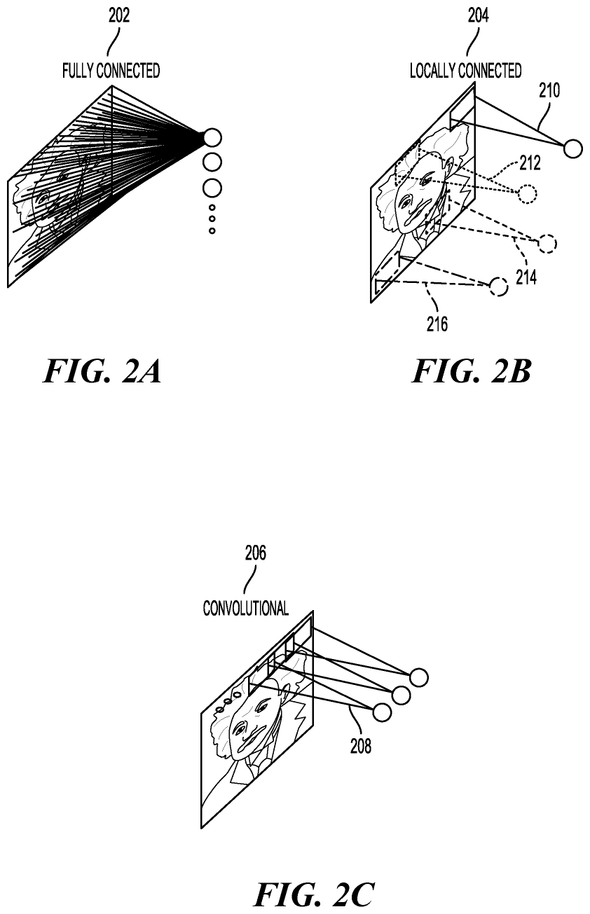

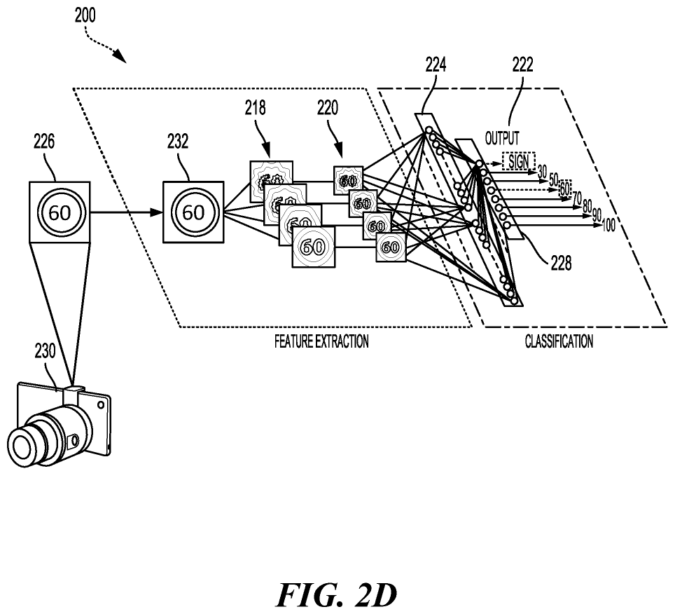

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

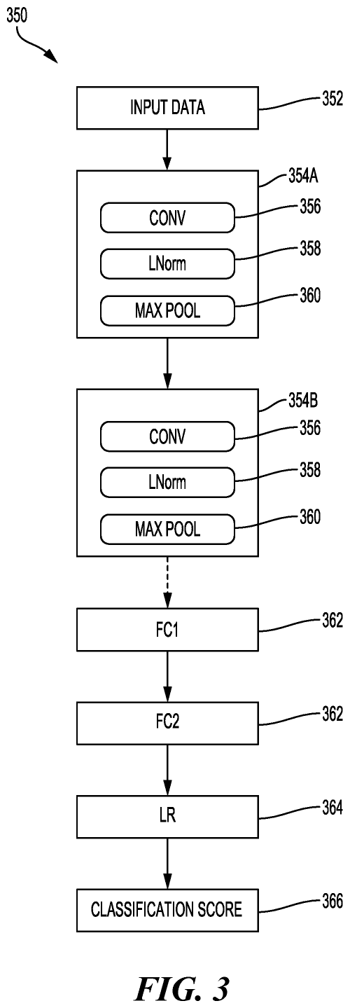

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layers 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

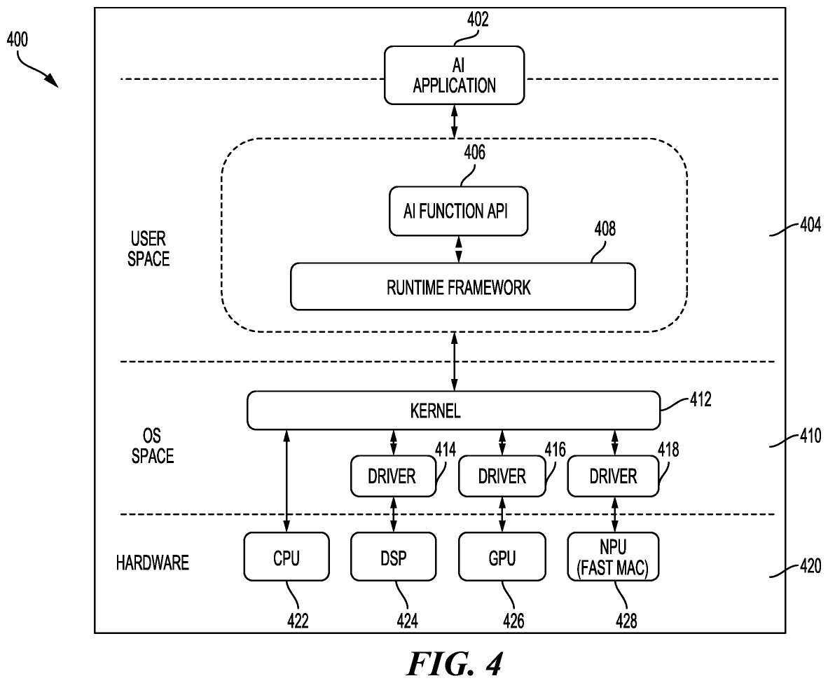

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support graph cuts for explainability and object-centric representation learning for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

Aspects of the present disclosure are directed to determining graph cuts for explainability of deep neural network models. In accordance with aspects of the present disclosure, graph cut methods may be incorporated in neural networks using linear processing formulations or specialized processes, for example. In one application, minimum s-t cut segmentation of images is employed for post-hoc explainability methods to improve the stability and quality of predictions.

In accordance with aspects of the present disclosure, graph cuts may be applied in per-instance post-hoc explainability for images using, for example, a learning-to-explain framework. That is, given a classification network, a second network may be configured to take a segment of the input and aims to match the predictions of the classifier. In other words, the second network attempts to determine a subset of the input that is important in generating the prediction output of the classification network. The second network may be referred to as an explainer network, and may generate a mask specifying which segment of the input to pass to the classification network.

Conventional methods use per-pixel weights and subset sampling methods to sample k element subsets. However, such conventional methods may discard more of the input structure, which may decrease the quality and stability of output predictions. To overcome such issues, aspects of the present disclosure may employ graph cut partitioning methods, which may retain more of the input (e.g., an image) structure compared with subsets. By implementing the graph cut methods, the explainer network may, for example, output the parameters of a graph minimum cut problem, considering the image as a graph. Solving the minimum cut problem may provide a partition of the pixels. Negative pixels may be masked in the image and positive pixels may be supplied to a downstream network. Moreover, techniques of the present disclosure may beneficially be applicable to object-centric representation learning and matching tasks.

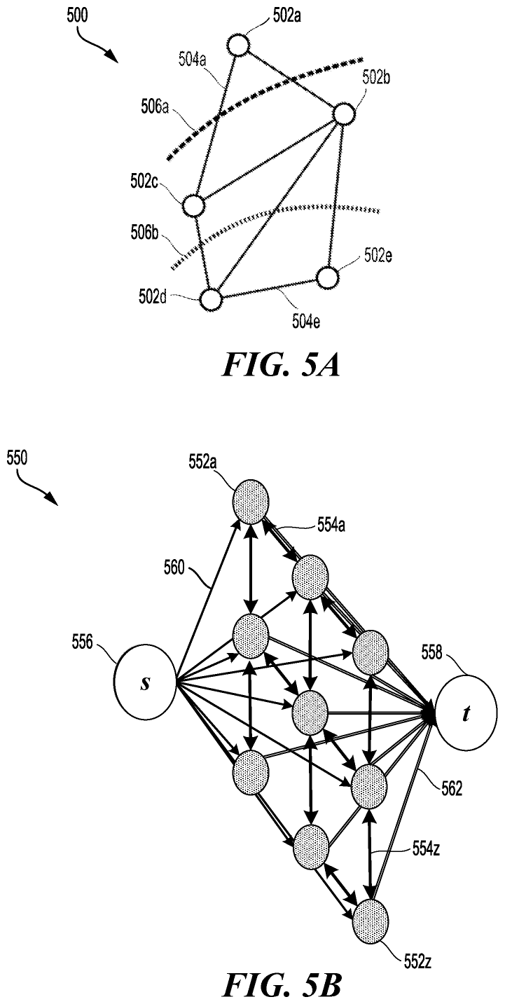

FIG. 5A is a diagram illustrating example cuts of an example graph 500, in accordance with various aspects of the present disclosure. As shown in FIG. 5A, the graph 500 includes a set of vertices 502 (which may also be referred to as nodes) coupled by edges 504. For ease of illustration, only two edges (e.g., 504a, 504e) are labeled. Furthermore, although the example graph includes five nodes (e.g., 502a-502e) and seven edges (e.g., 504a, 504e), this quantity is merely for ease of illustration and not limiting.

One or more graph cuts (e.g., 506a, 506b) may partition the graph 500 into two or more parts. Each graph cut 506a, 506b may partition the vertices (e.g., 502a-502e) into disjoint subsets. For instance, graph cut 506a may partition graph 500, separating vertex 502a from vertices 502b-502e. On the other hand, graph cut 506b may further partition the graph separating vertices 502b and 502c from vertices 502d and 502e. Additional cuts may also be included according to design preference.

FIG. 5B is a diagram illustrating an example graph 550 for illustrating an example minimum s-t cut problem, in accordance with various aspects of the present disclosure. As shown in FIG. 5B, the graph 550 may include a set of vertices 552 (e.g., 552a-552z) coupled together by a set of edges 554 (e.g., 554a-552z). For ease of illustration, element numbers are provided for only two instances of the vertices 552 and edges 554. The graph 550 may represent an image (e.g., an image graph) or a grid of input features, for instance. The edges 554 may represent a relationship among the vertices 552.

A source node s 556 may be coupled to each of the vertices 552 by edges 560. A sink node t 558 (may also be referred to as a sink node) may be coupled to each of the vertices 552 by edges 562. One goal of the minimum s-t cut problem may be to determine a cut or partition of the graph 550 such that a sum of the weights of the edges between the partition defined by the edges 560 coupled to the source node s 556 and the partition defined by edges 562 coupled to the sink node t 558 may be minimized. A partition may be realized by removing edges (e.g., 560 or 562) coupling a node (e.g., 552) to the source node s 556 or the sink node t 558.

As described, the minimum s-t cut problem has been used in computer vision and graphics for image segmentation, for example. The problem of image segmentation (e.g., into foreground and background) may be reduced to a minimum s-t cut by representing the image as a weighted grid graph (e.g., 550) with the vertices (e.g., 552) representing pixels where the weights on the edges (e.g., 554) may represent the similarity of neighboring pixels. The source vertex s (e.g., 556) and sink vertex t (e.g., 558) may be introduced such that for each pixel vertex v 552, edges (s, v) 560 and edges (v, t) 562 may be included. The weights w_{s,v} on edges 560 and weights w_{t,v} on edges 562 may represent relationships among the pixels of each partition (e.g., the relative background and foreground weight), respectively for the pixel vertex v. For example, w_{s,v}>w_{t,v} for a vertex 556 may indicate the pixel vertex v may be more likely to be related to a partition defined by the source vertex 556 than a partition defined by the sink vertex t 558 (e.g., more likely in the foreground rather than the background). At the same time, the neighboring edge weights w_{u,v} may indicate that similar pixels should be included in the same partition (e.g., partition defined by the source vertex 556). Solving the minimum cut problem on the graph may result in a segmentation of the image (e.g., into foreground and background). Employing such a process may encode an underlying image topology in the graph structure.

The graph cut problem may be formulated as a linear process. To do so, a variable pᵤ may be defined for each vertex u in the linear process. Similarly, for each edge (u, v), a variable denoted w_{u,v}, for edge weights, may also be defined. The edge weights w_{u,v} may act as objective function parameters in the linear process. The linear process may be written as follows.

$$minimize \sum {w}_{u v} {d}_{u v} \qquad ( 1 )$$

$$submit to {d}_{u v} \geq {p}_{u} - {p}_{v} ( u , v ) ∈ E ,$$

$${p}_{s} - {p}_{t} \geq 1 ,$$

$${d}_{u , v} \geq 0 ( u , v ) ∈ E ,$$

$${p}_{v} \geq 0 u ∈ V$$

where pₛ, pₜ pᵤ, pᵥ respectively correspond to vertices s, t, u, and v and dᵤᵥ corresponds to the edge (u, v).

The process may be supplied to a linear process solver to determine a solution, for example. Although there may be other methods of solving graph cut problems, the linear process formulation may provide a flexible solution that may be approximated with differentiable proxies.

Minimum s-t cuts in an image graph may, for instance, be determined using weights that may be parameterized by neural networks, w_{u,v}=f(x) with image x, for partitioning image feature maps, x′=g(x), into k disjoint partitions. Solving a standard minimum s-t cut problem can divide the vertex set of an input graph into two partitions. The minimum s-t cut problem may be generalized to partition a given graph into a fixed k number of partitions by solving k parallel minimum s-t cut problems, and subsequently, normalizing the vertex (or edge) variables to sum to one across k copies of the graph. The two partitions may also be formulated as a subset selection problem, for example. One advantage of using minimum s-t cuts for partitioning may be that the minimum s-t cuts approach depends on the underlying topology and neighborhood relations of image data represented in the image graph.

The minimum s-t cut for two partitions may be generalized to k-partitions by solving k parallel two partition problems and normalizing the vertex variables pᵤⁱ, where i denotes a partition index, from the optimized solution of Equation 1 with a softmax function over i. In some aspects, the k-partition problem may be solved with a single graph cut formulation. However, such a formulation may have a higher memory usage with increasing k.

There may be some obstacles associated with including linear processes as hidden layers in neural networks in a way that scales to solving large computer vision problems. One obstacle is that linear processes may not be continuously differentiable with respect to linear process parameters. Some conventional approaches utilize a quadratic programming relaxation technique. However, the gradient computation for such larger quadratic processes perform large matrix factorization, which may not be feasible in terms of compute time and memory when applied to image-scale data.

Another obstacle may be that established quadratic process solvers may operate on a CPU and cannot solve programs in large batches associated with fast neural network optimization. Some conventional approaches may attempt to solve general quadratic processes with GPU acceleration. However, in practice, such conventional approaches may not scale well to quadratic process solving in batch settings with the tens of thousands of variables and constraints that may arise when applied to image data.

Accordingly, aspects of the present disclosure differentiably solve approximations of the s-t cut problems as quadratic processes. The techniques disclosed may beneficially enable solutions for large batches of quadratic processes on GPUs and further application to image data.

Given an equality constrained quadratic process, the equality constrained quadratic process may be directly solved by computing the Karush-Kuhn-Tucker (KKT) matrix factorization and solving the resulting triangular system.

Linear or quadratic processes (e.g., for determining s-t cuts) may have non-negativity constraints for variables that may not be represented in equality constrained quadratic processes. Instead, regularization terms may be applied in the objective function, which may ensure that variables remain within a reasonable range. After solving the regularized equality constrained process, the solutions may be transformed, for example by a sigmoid function or softmax function, for example, to bring them within a desired range.

In some aspects, the minimum s-t cut linear process define in Equation 1 may be approximated by the following quadratic process with equality constraints:

$$minimize : \sum {w}_{u v} {d}_{u v} + γ {\sum }_{u , v} ( {d}_{u v}^{2} + {s}_{u v}^{2} ) + γ {\sum }_{v} {p}_{v}^{2} \qquad ( 2 )$$

$$subject to : {d}_{u v} - {s}_{u v} = {p}_{u} - {p}_{v} ( u , v ) ∈ E , {p}_{s} - {p}_{t} - {s}_{st} = 1 ,$$

where the variables sᵤᵥ are slack variables and γ is a regularization coefficient. One slack variable sᵤᵥ may be added per inequality constraint to convert the inequality constraints into equality constraints plus any non-negativity constraints. Next, a diagonal quadratic regularization term may be added for all variables, including slack variables in the objective function. Then, any non-negativity constraints may be removed to obtain a quadratic process with equality constraints only.

Given input features x, regularized equality constrained processes for s-t cuts may be included in artificial neural networks by parameterizing the edge weights w_{u,v}, for example, by a convolutional network (ConvNet) f as w=f(x).

Referring to FIG. 5B, in one example, each vertex 552 may be connected with four neighboring vertices as well as the source node s 556 and the sink node t 558 for a total of six edges per vertex 552 (e.g., five outgoing edges and one incoming edge). Given that the graph 550 has a height H and a width W, the weights for k-partitions may be parameterized using a ConvNet(f) with output dimensions (6 k, H, W), giving the weights six edges per pixel per partition. The output of the regularized equality constrained quadratic process for a minimum s-t cut may be interpreted as a cut after a softmax and may be applied for image-scale data.

The computations for solving regularized equality constrained quadratic processes and corresponding gradients may be defined relative to the objective function parameters. An equality constrained quadratic process may have the following form:

$$minimize \frac{1}{2} {z}^{t} {G}_{z} + {z}^{t} c \qquad ( 3 )$$

$$subject to Az = b ,$$

where Aϵ [symbol] is the constraint matrix including l constraints, bϵ [symbol] , Gϵ [symbol] and cϵ [symbol] . For quadratic process proxies for linear processes, G represents a multiple of identity, G=γI, corresponding to the regularization term γ, and c is a learnable parameter. In some aspects, the constraint matrix A and variable b may be fixed and may encode the graph constraints converted to equality constraints using the slack variables sᵤᵥ. Then, the non-negativity constraints may be removed.

The quadratic process may be solved directly by solving the following KKT optimality conditions for a dual vector λ:

$$[ \begin{matrix}G & {A}^{t} \\ A & 0\end{matrix} ] [ \begin{matrix}- z \\ λ\end{matrix} ] = [ \begin{matrix}c \\ - b\end{matrix} ] , \qquad ( 4 )$$

where the leftmost matrix is the KKT matrix. The inverse of the KKT matrix may be written using Gaussian elimination, with G=γI, as:

$${[ \begin{matrix}γ I & {A}^{t} \\ A & 0\end{matrix} ]}^{- 1} = [ \begin{matrix}C & E \\ {E}^{t} & F\end{matrix} ] , \qquad ( 5 )$$

$$where C = \frac{1}{γ} ( I - {{A}^{t} ( A {A}^{t} )}^{- 1} A ) , E = {{A}^{t} ( A {A}^{t} )}^{- 1} ,$$

and F=−(AA^{t})⁻¹. In Equation 5, (AA^{t})⁻¹ appears in inverted form and does not change. As such, (AA^{t})⁻¹ may be pre-computed. In some aspects, (AA^{t})⁻¹ may be pre-computed using a Cholesky factorization to factor AA^{t} as AA^{t}=LL^{t} in terms of a triangular factor L. Then, during training, the KKT system by computing Cz or Ez (Equation 5) for a value z may be efficiently solved by using forward and backward substitution with the triangular factor L.

Having determined the KKT matrix factorization of Equation 5, the KKT matrix may be used for the gradient computation. The gradient relative to parameters c may be determined by computing ∇_{c}l(c)=−C∇_{z}l(z), where l(.) is a loss function and z is a solution of the quadratic process. The Cholesky factor L may be used for the gradient, making the gradient computation more efficient.

Another challenge is that the constraint matrix A can be very large for object-centric applications because the image graph may scale quadratically with the image resolution. For example, 64×64 images may produce s-t cut quadratic processes with over 52,000 variables and over 23,000 constraints (e.g., may result in a constraint matrix having a size over four gigabytes (4 GB)), which may be solved in a batch for each training example. Because the constraints matrices may be highly sparse (about 6% non-zero elements for 64×64 images), sparse matrices and a sparse Cholesky factorization may be employed.

During training, batched sparse triangular solvers may be used for the backward and forward substitution to solve a batch of quadratic processes with different right-hand sides in Equation 4. Given a graph size of N, solving the quadratic process directly (e.g., with dense Cholesky factorization) may have a complexity of approximately O(N³) and may be even greater for general quadratic processes. Applying optimization techniques of the present disclosure may reduce the complexity to O(Nn_{z}), where n_{z} is the number of non-zero elements, which may be the time expended for a sparse triangular solver.

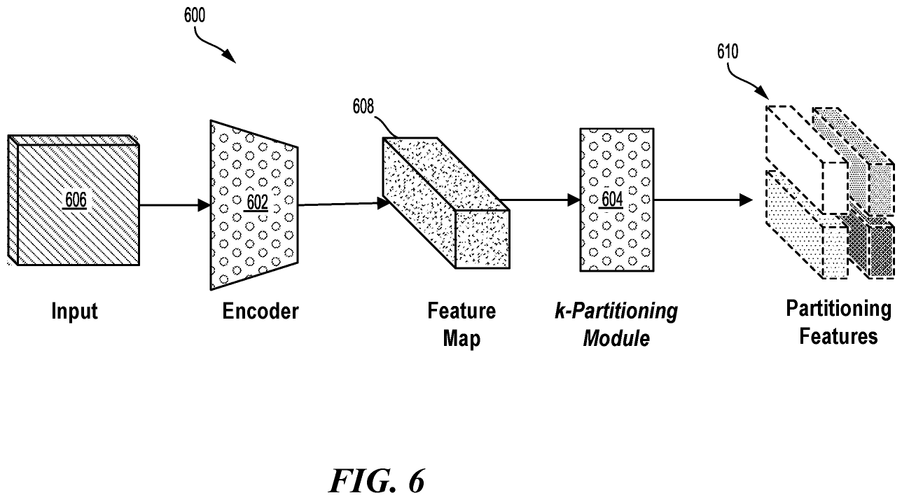

FIG. 6 is a block diagram illustrating an example architecture 600 for determining graph cuts, in accordance with various aspects of the present disclosure. The example architecture 600 may include an encoder 602 and a graph partitioning module (shown as k-partitioning module) 604. The encoder 602 may receive an input 606. The input 606 may comprise a graph. The graph may, for instance, represent (but is not limited to) an image or a grid of features. In one example, where the input 606 represents an image, the vertices of the graph may represent pixels of the image and the edges may represent a relationship between the pixels of the image.

The encoder 602 may extract features of the input 606 to generate a feature map 608. The feature map 608 may be supplied to the graph partitioning module 604. The graph partitioning module 604 may, in turn, partition the feature map 608 into two or more subsets or segments of features 610.

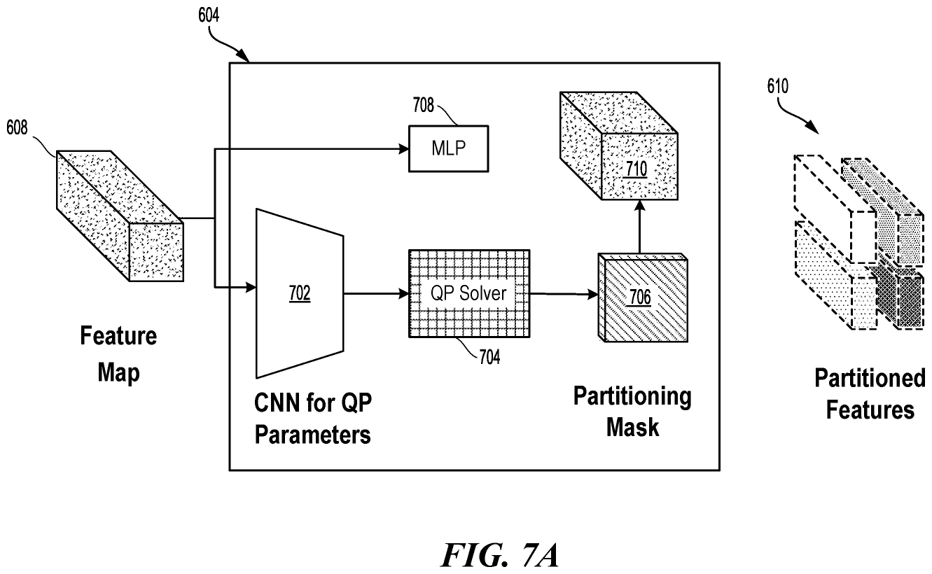

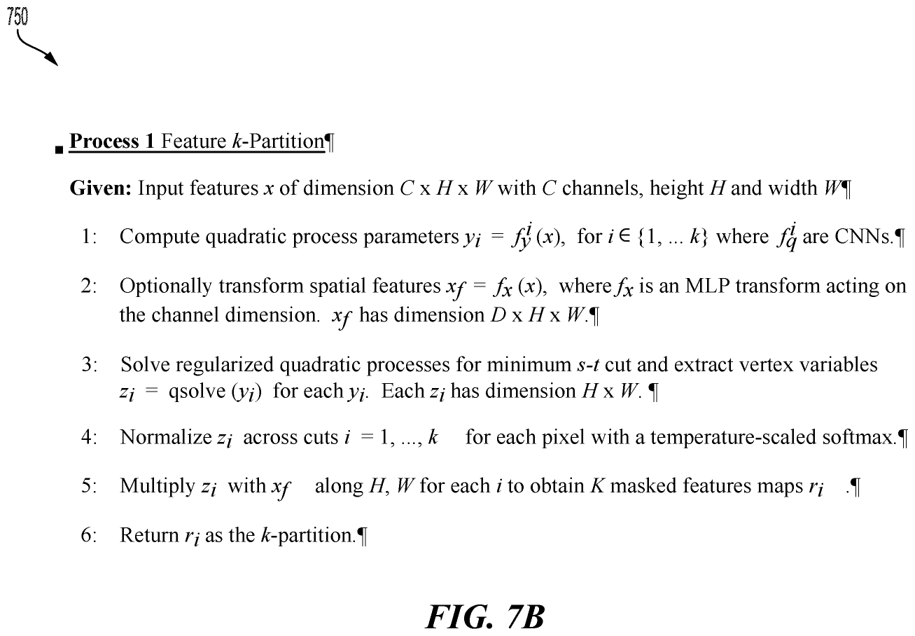

FIG. 7A is a block diagram illustrating the graph partitioning module 604 of FIG. 6 for partitioning a graph, in accordance with various aspects of the present disclosure. The graph partitioning module 604 may include an artificial neural network (ANN) 702, a quadratic process (QP) solver 704, and a multilayer perceptron (MLP) 708. The ANN 702 may comprise (but is not limited to) a convolutional neural network (CNN) (e.g., DCN 350 of FIG. 3). The ANN 702 may be configured to perform a quadratic process, such as the quadratic process with equality constraints only provided in Equation 2 or the equality constrained quadratic process defined in Equation 3, or another quadratic process, for example.

The ANN 702 may receive a feature map 608. The ANN 702 may apply the quadratic process to the feature map 608 to determine a set of quadratic process parameters. The quadratic process parameters may be provided to the quadratic process solver 704. In some aspects, the quadratic process solver 704 may comprise (but is not limited to a serial solver (e.g., Gurobi solver) or a parallel quadratic process solver, for instance. The quadratic process solver 704 may solve the quadratic process based on the quadratic process parameters to generate a partitioning mask 706.

In some aspects, the partitioning mask 706 may be a binary mask that indicates features to retain (e.g., indicated by a 1) or features to discard (e.g., indicated by a 0). The binary may in turn be applied to a grid of features 710. The partitioning mask 706 may be applied to the grid of features 710 to partition the grid of features 710 into two or more subsets or segments of features 610.

FIG. 7B is a diagram illustrating example pseudocode 750 for partitioning a graph, in accordance with various aspects of the present disclosure. A shown in FIG. 7B, an input (e.g., an image or a grid of features) may be represented as a graph. A set of quadratic process parameters may be determined based on the input, for instance using a CNN (line 1). A regularized quadratic process may be computed to determine on or more cuts or partitions in the graph (line 3). The regularized quadratic process may include equality constraints and may solve a minimum cut problem. The vertex variable for a cut set may be extracted. The extracted vertex variables may be normalized across the cuts for each pixel by applying a temperature-scaled softmax function (line 4), for instance. The normalized vertex variables may be multiplied by the spatial feature x_{f} to generate K masked feature maps rᵢ (e.g., K partitioned features) (line 5).

In some aspects, the regularized quadratic process framework may be extended to matching problems. Given two sets of k-partitions P₁ and P₂, the task may match partitions in P₁ and P₂, which may be treated as a bipartite matching problem. The bipartite matching problem may be specified according to the linear process given by:

$$minimize : \sum {c}_{u v} {d}_{u v} \qquad ( 6 )$$

$$subject to : {p}_{u} + {d}_{u , v} = 1 ,$$

$${p}_{v} + {d}_{u , v} = 1 \{ u , v \} ∈ E ,$$

$${d}_{u , v} \geq 0 \{ u , v \} ∈ E$$

The node variables may be denoted as pᵤ for node u, edge variables for edges {u, v} as d_{u,v}, and the edge cost as c_{u,v}.

Unlike the s-t cut problems, the bipartite matching problems may involve bipartite graphs that, for example, may include 2×12=24 nodes or less. For such smaller problems, CPU-based solvers or the parallel batched solution may be employed (e.g., after suitable relaxation). However, in some aspects, the same approach of approximating the regularized equality constrained quadratic processes for graph cut problems may be employed for the bipartite matching problems.

In some aspects, the k-partition formulation described may also be employed for object-centric representation learning. Object-centric representation learning aims to learn representations of individual objects in scenes given as static images or video. One way to formalize object-centric representation learning is to consider it as an input partitioning problem. In input partitioning problems, given a set of spatial scene features, the features may be partitioned into k per-object features, also called slots, for some given number of objects k. A useful characteristic for a partitioning scheme is topology-awareness. For example, the partitioning scheme should be aware that points close together in space may be related and may form part of the same object. A related problem is to match object representations in two closely related scenes, such as frames in video, to learn object permanence across space and time.

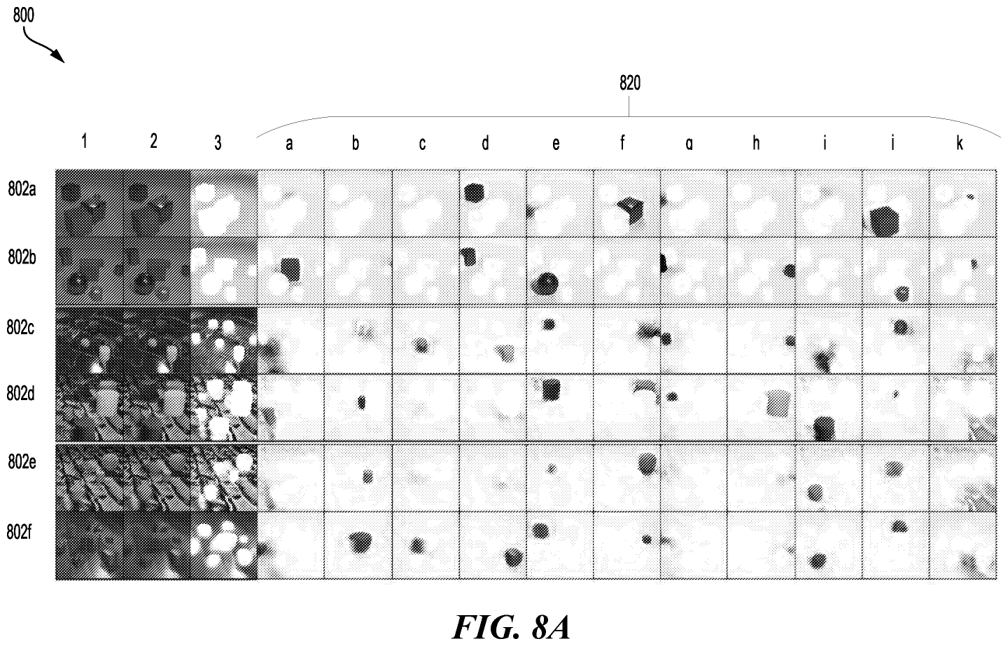

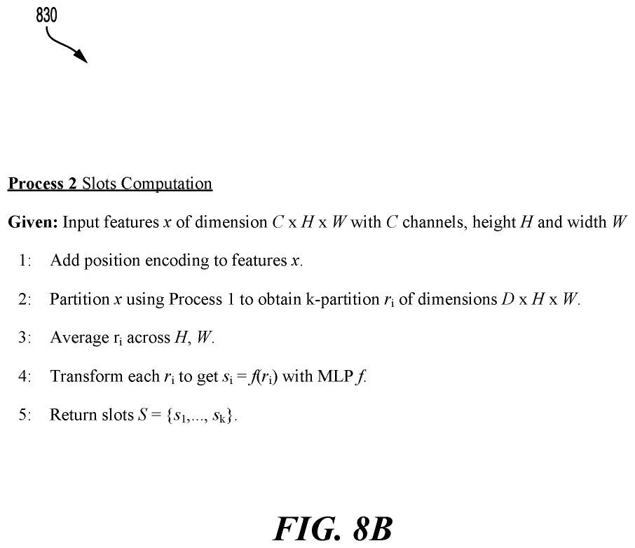

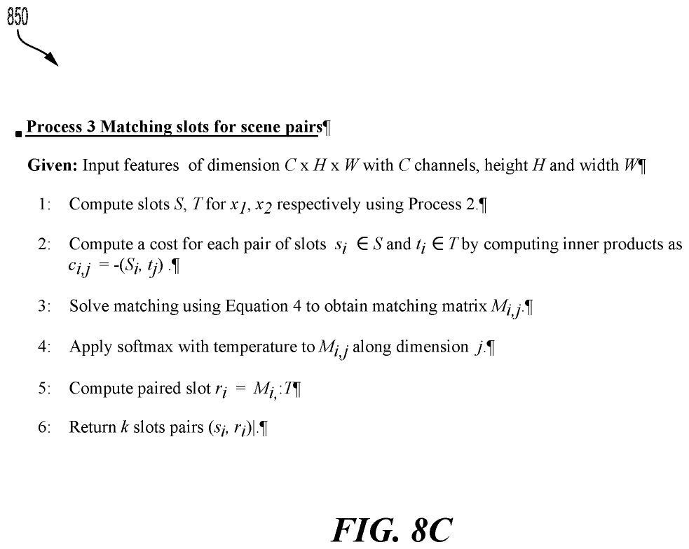

FIG. 8A is a diagram illustrating an example object-centric feature representation 800, in accordance with various aspects of the present disclosure. Referring to FIG. 8A, a set of different images 802a-802f may be supplied to an artificial neural network, such as the example architecture 600 of FIG. 6. The example architecture may process each of the images to determine a k-partition for each image 802a-802f Additionally, the k-partitions of features of the respective input images may be further processed to determine one or more features for each object in the images 802a-802f. By determining the features for each object in the respective images 802a-802f, the objects in the scene of each image may be reconstructed (e.g., shown in slots 820a-820k). The slots 820a-820k provide one slot for each object such that each slot 820a-820k may reconstruct an object discovered by the network (e.g., example architecture 600).

FIG. 8B is a diagram illustrating example pseudocode 830 for object-centric representation, in accordance with various aspects of the present disclosure. Given scene features, x, of dimension C×H×W as input (where C represents the channel, H represents the height, and W represents the width), the scene features x may be transformed into k vectors, referred to as slots. Each of the slots may correspond to and represent a specific object in the scene. The objective may be to determine graph cuts that preserve topological properties of the pixel space such that the neural network may learn to spatially group objects together in a coherent fashion, rather than assigning far-off regions to the same slot arbitrarily.

An encoder-decoder structure including a minimum s-t cut layer may be employed. Based on the scene features, which may, for example, be extracted by a CNN backbone, k minimum s-t cut quadratic process parameters may be computed using a smaller CNN. The k quadratic processes may be solved and softmax-normalization may be applied to the vertex variables to produce (soft) spatial masks zᵢ normalized across i. The spatial masks zᵢ may be multiplied with the (optionally transformed) scene features x broadcasting across the channel dimension. This results in masked features rt of dimensions D×H×W that form a k-partition (line 2 of FIG. 8B).

To obtain slot object representations, position encoding is added to the scene features x before partitioning (line 1). After partitioning, an average of each partition rt of dimension D×H×W across the spatial dimensions may be computed to obtain k vectors of dimension D (line 2). The k vectors may, in turn, be transformed, for example, by a multilayer perceptron to obtain the slots (line 4). Each slot may then be separately decoded. A separate output channel may combine the individual slot images. The combined image may be trained to reconstruct the original scene features x and/or the original scene.

In some aspects, the object-centric framework described may also be extended to a specialized background slot. A set of masks for two partitions and a set of masks for a k−1-partition, denoted mask foreground (mask_fg), mask background (mask_bg), and object mask (mask_object) may be computed. The mask foreground and the object mask may then be multiplied as mask_fg*mask_object to compute the specialized slot for the background.

FIG. 8C is a diagram illustrating example pseudocode 850 for object-centric representation, in accordance with various aspects of the present disclosure. The object representation learning may be extended to moving objects in video by combining the object-centric learning model with the matching process of pseudocode 850. Given a pair of frames of a video, for each frame, a k per-frame slot representation may be computed, for instance, as shown in pseudocode 830 of FIG. 8B (line 1). Using the linear matching process defined in Equation 6, a matching matrix M_{i,j} may be determined (line 3). A softmax function may be applied to the matching matrix M_{i,j} along the j-dimension. Then, using the matching process of pseudocode 850, the two sets of slots may be matched to produce new slots rᵢ (line 5). In some aspects, new slots may be transformed, for instance, by MLPs. A decoder (not shown) may process the new slot in a manner reciprocal to that of the encoder 602, for example, to reconstruct the input pair of frames by optimizing the sum of the reconstruction error for the two frames.

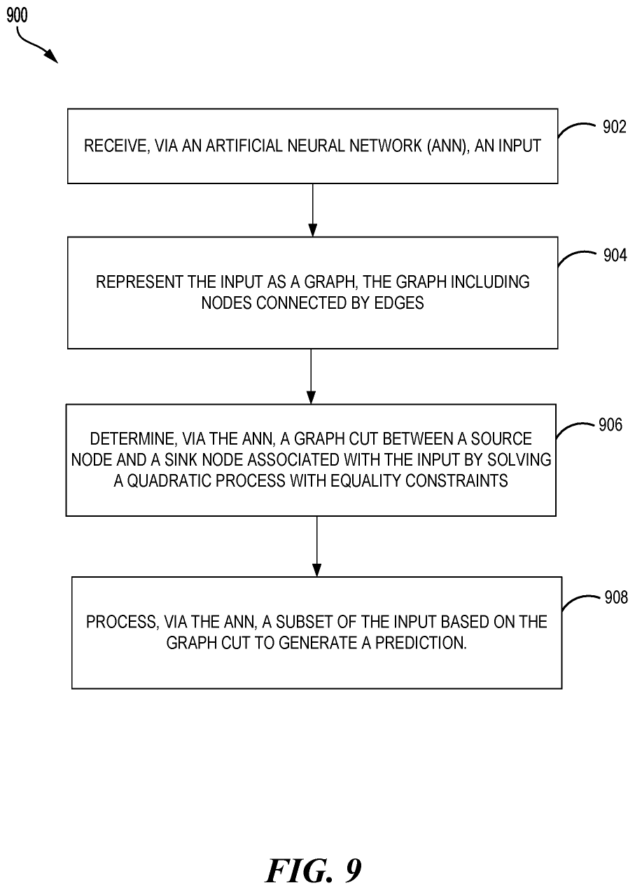

FIG. 9 is a flow diagram illustrating an example processor-implemented method 900 for implementing graph cuts for explainability using an artificial neural network, in accordance various with aspects of the present disclosure. The processor-implemented method 900 may be performed by one or more processors, such as the CPU (e.g., 102, 422), GPU (e.g., 104, 426), DSP (e.g., 106, 424), and/or NPU (e.g., 108, 428), for example.

As shown in FIG. 9, at block 902, the one or more processors receive, via an artificial neural network, an input. The input may, for example, comprise an image (which may also include but is not limited to frames of a video) or a grid of features, for example.

At block 904, the one or more processors represent the input as a graph, the graph including nodes connected by edges. For example, an image may be represented as a graph, in which each pixel is represented by a node of the graph. Additionally, a connection between each node may be weighted according to whether the pixel is on or not.

At block 906, the one or more processors determine, via the ANN, a graph cut between a source node and a sink node associated with the input by solving a quadratic process with equality constraints. As discussed, graph cuts may be applied in per-instance post-hoc explainability for images using, for example, a learning to explain framework. In some aspects, the graph cut may be a graph minimum source node-sink node cut. Other examples of graph cut include multi-cut problem and the multiway cut and minimum k-cut problems, all of which may be solved or approximated by linear processes.

At block 908, the one or more processors process, via the ANN, a subset of the input based on the graph cut to generate a prediction. As discussed, given a classification network, a second network may be configured to take a segment of the input and aims to match the predictions of the classifier. In other words, the second network attempts to determine a subset of the input that is important in generating the prediction output of the classification network.

Implementation examples are provided in the following numbered clauses.

1. An apparatus, comprising:
at least one memory; and
at least one processor coupled to the at least one memory, the at least one processor configured to:
   receive, via an artificial neural network (ANN), an input;
   represent the input as a graph, the graph including a plurality of nodes connected by edges;
   determine, via the ANN, a graph cut between a source node and a sink node associated with the input by solving a quadratic process with equality constraints; and
   process, via the ANN, a subset of the input based on the graph cut to generate a prediction.

2. The apparatus of clause 1, in which the graph cut segments the input such that a weight of cross edges between segments is smallest.

3. The apparatus of clause 1 or 2, in which the input is an image or a grid of features.

4. The apparatus of any of clauses 1-3, in which the plurality of nodes corresponds to pixels of the image or the grid of features.

5. The apparatus of any of clauses 1-4, in which the grid of features corresponds to image features of a scene including one or more objects in the image, and the at least one processor is further configured to divide the image features of the scene among the one or more objects.

6. The apparatus of any of clauses 1-5, in which the graph cut is differentiable.

7. The apparatus of any of clauses 1-6, in which the ANN includes one or more differentiable optimization layers.

8. A processor-implemented method, performed by at least one processor, the processor-implemented method comprising:
receiving, via an artificial neural network (ANN), an input;
representing the input as a graph, the graph including a plurality of nodes connected by edges;
determining, via the ANN, a graph cut between a source node and a sink node associated with the input by solving a quadratic process with equality constraints; and
processing, via the ANN, a subset of the input based on the graph cut to generate a prediction.

9. The processor-implemented method of clause 8, in which the graph cut segments the input such that a weight of cross edges between segments is smallest.

10. The processor-implemented method of clause 8 or 9, in which the input is an image or a grid of features.

11. The processor-implemented method of any of clauses 8-10, in which the plurality of nodes corresponds to pixels of the image or the grid of features.

12. The processor-implemented method of any of clauses 8-11, in which the grid of features corresponds to image features of a scene including one or more objects in the image, and the processor-implemented method further comprises dividing the image features of the scene among the one or more objects.

13. The processor-implemented method of any of clauses 8-12, in which the graph cut is differentiable.

14. The processor-implemented method of any of clauses 8-13, in which the ANN includes one or more differentiable optimization layers.

15. A non-transitory computer-readable medium having program code recorded thereon, the program code executed by at least one processor and comprising:
program code to receive, via an artificial neural network (ANN), an input;
program code to represent the input as a graph, the graph including a plurality of nodes connected by edges;
program code to determine, via the ANN, a graph cut between a source node and a sink node associated with the input by solving a quadratic process with equality constraints; and
program code to process, via the ANN, a subset of the input based on the graph cut to generate a prediction.

16. The non-transitory computer-readable medium of clause 15, in which the graph cut segments the input such that a weight of cross edges between segments is smallest.

17. The non-transitory computer-readable medium of clause 15 or 16, in which the input is an image or a grid of features.

18. The non-transitory computer-readable medium of any of clauses 15-17, in which the plurality of nodes corresponds to pixels of the image or the grid of features.

19. The non-transitory computer-readable medium of any of clauses 15-18, in which the grid of features correspond to image features of a scene including one or more objects in the image, and the program code further includes program code to divide the image features of the scene among the one or more objects.

20. The non-transitory computer-readable medium of any of clauses 15-19, in which the graph cut is differentiable.

21. The non-transitory computer-readable medium of any of clauses 15-20, in which the ANN includes one or more differentiable optimization layers.

22. An apparatus, comprising:
means for receiving, via an artificial neural network (ANN), an input;
means for representing the input as a graph, the graph including a plurality of nodes connected by edges;
means for determining, via the ANN, a graph cut between a source node and a sink node associated with the input by solving a quadratic process with equality constraints; and
means for processing, via the ANN, a subset of the input based on the graph cut to generate a prediction.

23. The apparatus of clause 22, in which the graph cut segments the input such that a weight of cross edges between segments is smallest.

24. The apparatus of clause 22 or 23, in which the input is an image or a grid of features.

25. The apparatus of any of clauses 22-24, in which the plurality of nodes corresponds to pixels of the image or the grid of features.

26. The apparatus of any of clauses 22-25, in which the grid of features corresponds to image features of a scene including one or more objects in the image, and further comprising means for dividing the image features of the scene among the one or more objects.

27. The apparatus of any of clauses 22-26, in which the graph cut is differentiable.

28. The apparatus of any of clauses 22-27, in which the ANN includes one or more differentiable optimization layers.

In one aspect, the receiving means, representing means, determining means, and/or processing means may be the GPU 104, program memory associated with the GPU 104, fully connected layers 362, NPU 428 and or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (TR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus, comprising:
at least one memory; and
at least one processor coupled to the at least one memory, the at least one processor configured to:
receive, via an artificial neural network (ANN), an input;
represent the input as a graph, the graph including a plurality of nodes connected by edges;
determine, via the ANN, a graph cut between a source node and a sink node associated with the input by solving a quadratic process with equality constraints; and
process, via the ANN, a subset of the input based on the graph cut to generate a prediction.

2. The apparatus of claim 1, in which the graph cut segments the input such that a weight of cross edges between segments is smallest.

3. The apparatus of claim 1, in which the input is an image or a grid of features.

4. The apparatus of claim 3, in which the plurality of nodes corresponds to pixels of the image or the grid of features.

5. The apparatus of claim 3, in which the grid of features corresponds to image features of a scene including one or more objects in the image, and the at least one processor is further configured to divide the image features of the scene among the one or more objects.

6. The apparatus of claim 1, in which the graph cut is differentiable.

7. The apparatus of claim 1, in which the ANN includes one or more differentiable optimization layers.

8. A processor-implemented method, performed by at least one processor, the processor-implemented method comprising:
receiving, via an artificial neural network (ANN), an input;
representing the input as a graph, the graph including a plurality of nodes connected by edges;
determining, via the ANN, a graph cut between a source node and a sink node associated with the input by solving a quadratic process with equality constraints; and
processing, via the ANN, a subset of the input based on the graph cut to generate a prediction.

9. The processor-implemented method of claim 8, in which the graph cut segments the input such that a weight of cross edges between segments is smallest.

10. The processor-implemented method of claim 8, in which the input is an image or a grid of features.

11. The processor-implemented method of claim 10, in which the plurality of nodes corresponds to pixels of the image or the grid of features.

12. The processor-implemented method of claim 10, in which the grid of features corresponds to image features of a scene including one or more objects in the image, and the processor-implemented method further comprises dividing the image features of the scene among the one or more objects.

13. The processor-implemented method of claim 8, in which the graph cut is differentiable.

14. The processor-implemented method of claim 8, in which the ANN includes one or more differentiable optimization layers.

15. A non-transitory computer-readable medium having program code recorded thereon, the program code executed by at least one processor and comprising:
program code to receive, via an artificial neural network (ANN), an input;
program code to represent the input as a graph, the graph including a plurality of nodes connected by edges;
program code to determine, via the ANN, a graph cut between a source node and a sink node associated with the input by solving a quadratic process with equality constraints; and
program code to process, via the ANN, a subset of the input based on the graph cut to generate a prediction.

16. The non-transitory computer-readable medium of claim 15, in which the graph cut segments the input such that a weight of cross edges between segments is smallest.

17. The non-transitory computer-readable medium of claim 15, in which the input is an image or a grid of features.

18. The non-transitory computer-readable medium of claim 17, in which the plurality of nodes corresponds to pixels of the image or the grid of features.

19. The non-transitory computer-readable medium of claim 17, in which the grid of features correspond to image features of a scene including one or more objects in the image, and the program code further includes program code to divide the image features of the scene among the one or more objects.

20. The non-transitory computer-readable medium of claim 15, in which the graph cut is differentiable.

21.-28. (canceled)
